(19) United States
(12) Patent Application Publication
(10) Pub. No.: US 2017/0154640 A1
(43) Pub. Date: Jun. 1, 2017

(54) METHOD AND ELECTRONIC DEVICE FOR VOICE RECOGNITION BASED ON DYNAMIC VOICE MODEL SELECTION

(71) Applicants: LE HOLDINGS (BEIJING) CO., LTD., Beijing (CN); LE SHI ZHI XIN ELECTRONIC TECHNOLOGY (TIAN JIN) LIMITED, Beijing (CN)

(72) Inventor: Yongqing WANG, Beijing (CN)

(21) Appl. No.: 15/241,617

(22) Filed: Aug. 19, 2016

Related U.S. Application Data
(63) Continuation of application No. PCT/CN2016/082539, filed on May 18, 2016.

(30) Foreign Application Priority Data
Nov. 26, 2015 (CN) 201510849106.3

(51) Int. Cl. G10L 25/87; G10L 25/24; G10L 17/04; G10L 25/75; G10L 25/51

(52) U.S. Cl. CPC G10L 25/87; G10L 25/75; G10L 25/51; G10L 17/04; G10L 25/24

(57) ABSTRACT

The embodiments of the present disclosure provide a method and a device for voice recognition based on dynamic voice model selection. Wherein, the method includes: obtaining a first voice packet of a voice to be detected and extracting the basic frequency of the first voice packet, wherein the basic frequency is the vibration frequency of a vocal cord; classifying the sources of the voice to be detected according to the basic frequency and selecting a pre-trained voice model voice model in a corresponding category; and performing front-end processing on the voice to be detected to obtain the values of the characteristic parameters of the voice to be detected, and matching the processed voice to be detected with the voice model and scoring, thus obtaining a voice recognition result.

### CROSS REFERENCE TO RELATED APPLICATIONS

This application is a continuation application of PCT international application No. PCT/CN2016/082539, filed on May 18, 2016, which claims priority to Chinese Patent Application No. 201510849106.3, filed on Nov. 26, 2015, the entire contents of which are incorporated herein by reference.

### TECHNICAL FIELD

This relates generally to the field of voice recognition, including but not limited to a method and a device for voice recognition based on dynamic voice model selection.

### BACKGROUND

Voice recognition is an interdisciplinary technology which has gradually moved from the laboratory towards the market in recent years. It is expected that a voice recognition technology will enter various fields like industry, household appliances, communications, automotive electronics, medical care, family services, consumer electronics, or the like, in the next 10 years. The application of a voice recognition dictation machine in some fields is named one of the ten events of computer development in 1997 by the US Press. Fields covered by the voice recognition technology include: signal processing, pattern recognition, probability theory and information theory, sounding mechanism and hearing mechanism, artificial intelligence, etc.

In an internet voice recognition application system, a universal voice model is trained usually, and male voice training data is dominant; therefore, the voice recognition rates of the female and children of using a universal model for voice recognition are apparently lower than that of the male in the recognition stage, resulting in the reduction of the overall user experience of the voice recognition system.

In order to solve this problem, the present solution is to adopt model adaptation including unsupervised and supervised model adaptation. Both of the two solutions have substantial defects. For the unsupervised model adaptation, the defects thereof are that the trained model may possibly have a large offset which is in inverse ratio to the training time; for the supervised model adaptation, the training processor requires the participation of the female and children, which requires a large number of human and material resources, and the cost will be very high.

Therefore, it is highly desirable to propose a high-efficiency and low-cost method and device for voice recognition.

### SUMMARY

Some embodiments of the present disclosure provide a method and a device for voice recognition based on dynamic voice model selection, for solving the defect in the prior art that the voice recognition rates of the female and children are apparently lower, and implementing effective and accurate voice recognition.

Some embodiments of the present disclosure provide a method for voice recognition based on dynamic voice model selection, including:

obtaining a first voice packet of a voice to be detected and extracting the basic frequency of the first voice packet, wherein the basic frequency is the vibration frequency of a vocal cord;

classifying the sources of the voice to be detected according to the basic frequency and selecting a pre-trained voice model in a corresponding category; and

performing front-end processing on the voice to be detected to obtain the values of the characteristic parameters of the voice to be detected, and matching the processed voice to be detected with the voice model and scoring, thus obtaining a voice recognition result.

Some embodiments of the present disclosure provide a device for voice recognition based on dynamic voice model selection, including:

a basic frequency extraction module configured to obtain a first voice packet of a voice to be detected and extract the basic frequency of the first voice packet, wherein the basic frequency is the vibration frequency of a vocal cord;

a classification module configured to classify the sources of the voice to be detected according to the basic frequency and select a pre-trained voice model in a corresponding category; and

a voice recognition module configured to perform front-end processing on the voice to be detected to obtain the values of the characteristic parameters of the voice to be detected, and match the processed voice to be detected with the voice model and score, thus obtaining a voice recognition result.

Some embodiments of the present disclosure provide an electronic device for voice recognition based on dynamic voice model selection, including:

at least one processor; and

a memory communicably connected with the at least one processor for storing instructions executable by the at least one processor, wherein execution of the instructions by the at least one processor causes the at least one processor to:

obtain a first voice packet of a voice to be detected and extract the basic frequency of the first voice packet, wherein the basic frequency is the vibration frequency of a vocal cord;

classify the sources of the voice to be detected according to the basic frequency and select a pre-trained voice model voice model in a corresponding category; and

perform front-end processing on the voice to be detected to obtain the values of the characteristic parameters of the voice to be detected, and match the processed voice to be detected with the voice model and score, thus obtaining a voice recognition result.

The system for voice recognition provided by the present invention may dynamically select a speaker model for recognition through detecting the category of the speaker, may improve the recognition rates of the female and children, and has the advantages of high efficiency and low cost.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for voice recognition in the prior art;

FIG. 2 is a flow chart of some embodiments of a method for voice recognition of the present disclosure;

FIG. 3 is a structural diagram of some embodiments of a device for voice recognition of the present disclosure; and

FIG. 4 is a block diagram of an electronic device in accordance with some embodiments.

### DESCRIPTION OF THE EMBODIMENTS

To make the objects, technical solutions and advantages of some embodiments of the present disclosure more clearly, the technical solutions of the present disclosure will be clearly and completely described hereinafter with reference to some embodiments and drawings of the present disclosure. Apparently, some embodiments described are merely partial embodiments of the present disclosure, rather than all embodiments. Other embodiments derived by those having ordinary skills in the art on the basis of some embodiments of the disclosure without going through creative efforts shall all fall within the protection scope of the present disclosure.

It should be illustrated that some embodiments of the present disclosure do not exist independently, and a plurality of embodiments may exist in a mutually complemented or combined manner. For example, the first embodiment and the second embodiment respectively elaborate the voice recognition phase and the voice model training phase in some embodiments of the present disclosure, the second embodiment is the support of the first embodiment, and the combination of the two is a more complete technical solution.

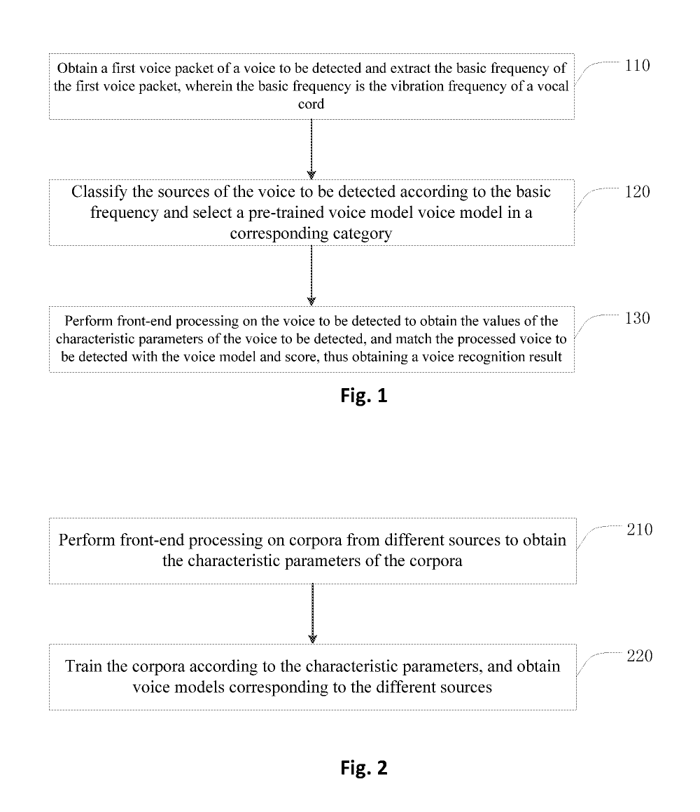

FIG. 1 is a technical flow chart of some embodiments of the present disclosure. With reference to FIG. 1, a method for voice recognition based on dynamic voice model selection of some embodiments of the present disclosure is mainly implemented through the several steps as follows.

In step 110: a first voice packet of a voice to be detected is obtained and the basic frequency of the first voice packet is extracted, wherein the basic frequency is the vibration frequency of a vocal cord;

The core of some embodiments of the present disclosure is to determine in advance the source of a voice requesting for voice recognition before voice recognition, the male, female or children. Thus selecting a voice model matched based on the source of the voice for voice recognition improves the accuracy rate of the voice recognition.

When a voice input is detected, sampling the voice signal, and choosing the voice recognition model for selection based on the sampled signal. The starting time of sampling and the signal length of the sampled signals are very critical. Detection starts after the sampling of part of the voice signal close to the initial point, which leads to determination of the voice signal source. The voice recognition efficiency and user experiences are improved due to the rapid determination of the voice signal source. As for the signal length, a small sampling interval is not sufficient to determine the collected samples correctly and leads to more false detection. While an oversize sampling interval will prolong the time between the voice input and the voice source detection, which will result in slow recognition and poor user experience. Usually, the sampling interval greater than 0.3 s leads to a preferable detection performance. In some embodiments of this disclosure, setting the initial point of the sampling time to the same as the initial point of the voice input and setting the sampling interval to 0.5 s.

voice activity detection (VAD) is performed on the voice signal to be detected firstly, i.e., determining the initial point and end point of the voice signal from a section of signal including voice, obtaining the voice data from the initial point to about 0.5 s after the time point as the first voice packet, and determining the sources of the voice quickly and accurately according to the first voice packet.

In step 120: the sources of the voice to be detected are classified according to the basic frequency and a pre-trained voice model in a corresponding category is selected.

During the pronunciation process of sonant, an air flow drives the vocal cord to vibrate in a relaxation oscillation manner through a glott is to produce a quasi-periodic pulse air flow which stimulates a sound channel to produce sonant that carries most energy in the voice, wherein the vibration frequency of the vocal cord is the basic frequency.

In some embodiments of the present disclosure, the basic frequency of the first voice packet is extracted employing an algorithm based on time-domain and/or an algorithm based on spatial-domain, wherein the algorithm based on time-domain includes an autocorrelation function algorithm and an average magnitude difference function algorithm, and the algorithm based on spatial-domain includes a cepstrum analysis method and a discrete wavelet transform method.

The autocorrelation function algorithm utilizes the quasi-periodicity of a sonant signal and detects the basic frequency by comparing similarity between the original signal and a displacement signal, a peak value is provided by the autocorrelation function of the sonant signal when the time delay is the integer multiples of the pitch period, while the autocorrelation function of an unvoiced signal does not have an apparent peak value. Therefore, the basic frequency of the voice can be estimated by detecting the position of the peak value of the autocorrelation function of the voice signal.

The principle for detecting the basic frequency through the average magnitude difference function algorithm is: the sonant signal of the voice is quasi-periodic, and the amplitude values of a completely periodic signal on certain points should be the same, if the distance between these points are any integral multiple of the period, and the difference of the amplitude values of a completely periodic signal on these certain points is zero. It is provided that the pitch period is P, then the average magnitude difference function will have a valley at a sonant segment, while the distance between the valleys is the pitch period, and the reciprocal thereof is the basic frequency.

Cepstrum analysis is a spectrum analysis method, and the output is the inverse Fourier transform of the logarithm form of an amplitude spectrum of Fourier transform. The theory behind the method is that the amplitude spectrum of Fourier transform of a signal with a basic frequency has some equidistantly distributed peak values that represent a harmonic structure of the signal, these peak values are lower to a useable range after taking the logarithm of the amplitude spectrum. The logarithm of the amplitude spectrum is a periodic signal in a frequency domain, while the period (frequency value) of the frequency domain signal is the basic frequency of the original signal. Therefore, there is a peak value at the pitch period points of the original signal by performing inverse Fourier transform on the signal.

Discrete wavelet transform is a tool for decomposing the signal into high-frequency components and low-frequency components with a continuous scale. Wavelet analysis is the local transform of time and frequency, and can effectively extract information from the signal. Compared with fast Fourier transform, the discrete wavelet transform has the major advantages of being capable of obtaining a fine time resolution at a high-frequency part and obtaining a fine frequency resolution at a low-frequency part.

In some embodiments of the present disclosure, different types of voice models are trained according to the sources of the voice samples, such as a male voice model, a female voice model and a child voice model, etc. Meanwhile, a corresponding basic frequency threshold is set for each of the different types, wherein the value range of the basic frequency threshold is obtained through a experiments.

The basic frequency depends on the size, thickness and relaxation of the vocal cord as well as the effect of the pressure difference between the upper and lower of the glottis, or the like. When the vocal cord is longer, tighter and thinner, the shape of the glottis becomes slender, and the vocal cord at this moment may not be completely closed during closing, then the corresponding basic frequency is higher. The basic frequency is decided according to the sexuality, age and details of a speaker. Generally, the basic frequencies of the old male are lower and the basic frequencies of the female and children are higher. Upon testing, the basic frequency range of the male is between 80 Hz and 200 Hz in general, the basic frequency range of the female is between 200-350 HZ, while the basic frequency range of children is between 350-500 Hz.

When a section of voice input requests voice recognition, the basic frequency of the voice input is extracted, and the threshold range thereof is determined; in this way, whether the voice input is from the male, the female or children can be determined.

Selecting the voice model according to the category of the sources of the voice to be detected may include the four situations as follows:

if the voice to be detected is from the male, then a male voice model is selected;

if the voice to be detected is from the female, then a female voice model is selected;

if the voice to be detected is from children, then a child voice model is selected; and

if there is no detection result or the voice to be detected is from others, then a universal voice model is selected for recognizing the voice to be detected.

In step 130: front-end processing is performed on the voice to be detected to obtain the values of the characteristic parameters of the voice to be detected, and matching the processed speech to be detected with the speech model and scoring, thus obtaining a voice recognition result.

The front-end processing performed on corpora mainly extracts the characteristic parameters of the voice, wherein the characteristic parameters of the voice include a Mel frequency cepstrum coefficient (MFCC), a linear prediction coefficient (LPC), a linear prediction cepstrum coefficient (LPCC), or the like, which will not be limited in some embodiments of the present disclosure. Because the MFCC imitates the processing characteristics of a human ear on the voice to some extent, the MFCC is extracted as the characteristic parameter in some embodiments of the disclosure.

The calculation steps of the MFCC is as follows: the voice signal is subjected to sectioned Fourier transform to obtain the frequency spectrum thereof; the square of amplitude of the frequency spectrum (i.e., energy spectrum) is determined, and band-pass filtering is performed on the energy in the frequency domain using a group of triangle filters; the value of the MFCC is the inverse Fourier transform or DCT transform of the output of the filters which is in the logarithm form.

In some embodiments of the present disclosure, the matching the processed voice to be detected with the voice model and scoring is to actually match the MFCC value of the voice to be detected with the MFCC value in the trained voice model and calculate the score of the matching rate of the the processed voice to be detected and the voice model, thus obtaining a recognition result.

It should be illustrated that the process of performing front-end processing on the voice to be detected during the voice recognition phase and the process of performing front-end processing on corpus samples during the training phase are the same, and the characteristic parameters selected are the same; in this way, the values of the characteristic parameters are comparable.

According to some embodiments, voice activity detection is performed on the voice to be detected firstly to obtain the initial point of the voice to be detected, and then the voice to be detected is subpackaged; after the data of the first voice packet is obtained, then voice source category detection (SCD) is performed on the first voice packet to determine whether the voice to be detected belongs to the male, the female or children, and select a corresponding voice model corresponding to the voice source; voice recognition is performed by extracting the characteristic parameters of the voice to be detected, so as to obtain the recognition result. The embodiment implements recognition based on dynamically selecting the voice model through detecting the category of the voice source, improves the voice recognition rates of the female and children, and has the advantages of high efficiency and low cost at the same time.

FIG. 2 is a technical flow chart of some embodiments of the present disclosure. With reference to FIG. 2, training a voice model corresponding to different voice sources in advance in a method for voice recognition based on dynamic voice model selection of some embodiments of the present disclosure is implemented through the following steps.

In step 210: front-end processing is performed on corpora from different sources to obtain the characteristic parameters of the corpora.

The performing process and technical effects of the step are the same as that of step 130.

In step 220: the corpora are trained according to the characteristic parameters to obtain voice models corresponding to the different sources.

the characteristic parameters extracted respectively from the corpora from various sources are utilized to perform four types of model training respectively, i.e., male corpora are used for training a male voice model; female corpora are used for training a female voice model; children corpora are used for training a child voice model; and the mixed corpora of the three are used for training a universal voice model.

In some embodiments of the present disclosure, HMM, GMM-HMM and DNN-HMM, or the like, can be used for training the voice model.

HMM (Hidden Markov Model) is short for Hidden Markov Model. HMM is a Markov chain, the state of which cannot be directly observed, but can be observed through an observation vector sequence; each observation vector is represented in various states through some probability density distribution, and each observation vector is produced by a state sequence having corresponding probability density distribution. Therefore, the hidden Markov model is a double random process—having a hidden Markov chain with a certain number of states and explicated a random function set. HMM has been applied to voice recognition since 1980s successfully. GMM and DNN are short for Gaussian mixture model and depth neuronic network model respectively.

Both GMM-HMM and DNN-HMM are modifications based on HMM. Because all these three models are mature prior arts, and are not the protective emphases of some embodiments of the present disclosure, the three models will not be elaborated herein.

In some embodiments, several voice models matched with the voice sources are obtained by extracting the characteristic parameters of the present corpora from different sources and training the voice models, and the voice models are used for voice recognition, which can effectively improve the relative recognition rates of the female voice and the child voice.

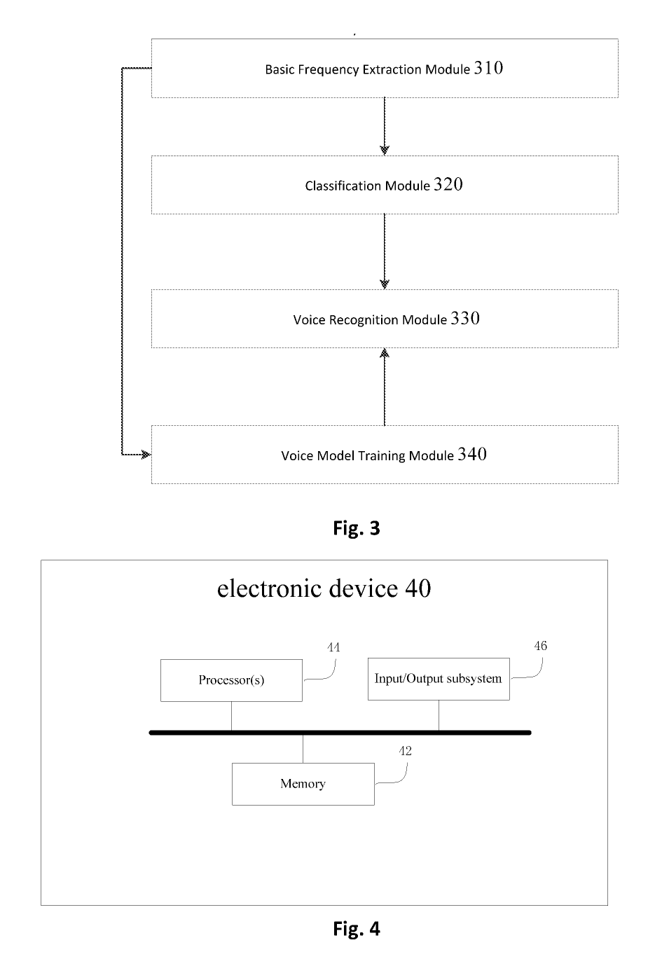

FIG. 3 is a structural diagram of a device of some embodiments of the present disclosure. With reference to FIG. 3, a device for voice recognition based on dynamic voice model selection of some embodiments of the present disclosure includes the several modules as follows: a basic frequency extraction module 310, a classification module 320, a voice recognition module 330 and a voice model training module 340.

The basic frequency extraction module 310 is configured to obtain a first voice packet of a voice to be detected and extract the basic frequency of the first voice packet, wherein the basic frequency is the vibration frequency of a vocal cord.

The classification module 320 is connected with the basic frequency extraction module 310 and invokes the value of the basic frequency extracted by the basic frequency extraction module 310, classifies the sources of the voice to be detected according to the basic frequency and selects a pre-trained voice model voice model in a corresponding category.

The voice recognition module 330 is connected with the classification module 320 and is configured to perform front-end processing on the voice to be detected to obtain the values of the characteristic parameters of the voice to be detected, and match the processed voice to be detected with the voice model classified and obtained by the classification module 320 and score, thus obtaining a voice recognition result.

The basic frequency extraction module 310 is further configured to: perform voice activity detection on the voice to be detected to obtain the initial point of the voice to be detected; and serve a voice signal with a certain time range after the initial point as the first voice packet.

The basic frequency extraction module 310 is further configured to: extract the basic frequency of the first voice packet using an algorithm based on time-domain and/or an algorithm based on spatial-domain, wherein the algorithm based on time-domain includes an autocorrelation function algorithm and an average magnitude difference function algorithm, and the algorithm based on spatial-domain includes a cepstrum analysis method and a discrete wavelet transform method.

The classification module 330 is configured to: determine the threshold range to which the basic frequency belongs according to a preset basic frequency threshold and classify the sources of the voice to be detected according to the threshold range, wherein the threshold range has a unique corresponding relation with different sources of the voice.

The device further includes a voice model training module 340 which is configured to: perform front-end processing on corpora from different sources to obtain the characteristic parameters of the corpora; and train the corpora according to the characteristic parameters, and obtain voice models corresponding to the different sources.

The device as shown in FIG. 2 may perform the methods of some embodiments as shown in FIG. 1 and FIG. 2, and please refer to the embodiments as shown in FIG. 1 and FIG. 2 for the implementing principles and technical effects which will not be elaborated.

Attention is now directed toward embodiments of an electronic device. FIG. 4 is a block diagram illustrating an electronic device 40. The electronic device may include memory 42 (which may include one or more computer readable storage mediums), at least one processor 44, and input/output subsystem 46. These components may communicate over one or more communication buses or signal lines. It should be appreciated that the electronic device 40 may have more or fewer components than shown, may combine two or more components, or may have a different configuration or arrangement of the components. The various components may be implemented in hardware, software, or a combination of both hardware and software.

The at least one processor 44 may be configured to execute software (e.g. a program of one or more instructions) stored in the memory 42. For example, the at least one processor 44 may be configured to operate in accordance with the method of FIG. 1, the method of FIG. 2, or a combination thereof. To illustrate, the at least one processor 44 may be configured to execute the instructions that cause the at least one processor to:

obtain a first voice packet of a voice to be detected and extract the basic frequency of the first voice packet, wherein the basic frequency is the vibration frequency of a vocal cord;

classify the sources of the voice to be detected according to the basic frequency and select a pre-trained voice model voice model in a corresponding category; and

perform front-end processing on the voice to be detected to obtain the values of the characteristic parameters of the voice to be detected, and match the processed voice to be detected with the voice model and score, thus obtaining a voice recognition result.

As another example, the obtain the first voice packet of the voice to be detected further includes:

perform voice activity detection on the voice to be detected to obtain the initial point of the voice to be detected; and

serve a voice signal with a certain time range after the initial point as the first voice packet.

As another example, the serve the voice signal with the certain time range after the initial point as the first voice packet particularly includes:

obtain the voice data from the initial point to 0.3˜0.5 s after the time point as the first voice packet.

As another example, the extract the basic frequency of the first voice packet further includes:

extract the basic frequency of the first voice packet employing an algorithm based on time-domain and/or an algorithm based on spatial-domain, wherein the algorithm based on time-domain includes an autocorrelation function algorithm and an average magnitude difference function algorithm, and the algorithm based on spatial-domain includes a cepstrum analysis method and a discrete wavelet transform method.

As another example, the classify the sources of the voice to be detected according to the basic frequency further includes:

determine the threshold range to which the basic frequency belongs according to a preset basic frequency threshold and classify the sources of the voice to be detected according to the threshold range, wherein the threshold range has a unique corresponding relation with different sources of the voice.

As another example, the instruction may further cause the at least one processor to:

perform front-end processing on corpora from different sources to obtain the characteristic parameters of the corpora; and

train the corpora according to the characteristic parameters, and obtain voice models corresponding to the different sources.

The device embodiments described above are only exemplary, wherein the units illustrated as separation parts may either be or not physically separated, and the parts displayed by units may either be or not physical units, i.e., the parts may either be located in the same place, or be distributed on a plurality of network units. A part or all of the modules may be selected according to an actual requirement to achieve the objectives of the solutions in the embodiments. Those having ordinary skills in the art may understand and implement without going through creative work.

Through the above description of the implementation manners, those skilled in the art may clearly understand that each implementation manner may be achieved in a manner of combining software and a necessary common hardware platform, and certainly may also be achieved by hardware. Based on such understanding, the foregoing technical solutions essentially, or the part contributing to the prior art may be implemented in the form of a software product. The computer software product may be stored in a storage medium such as a ROM/RAM, a diskette, an optical disk or the like, and includes several instructions for instructing a computer device (which may be a personal computer, a server, or a network device so on) to execute the method according to each embodiment or some parts of the embodiments.

It should be finally noted that the above embodiments are only configured to explain the technical solutions of the present disclosure, but are not intended to limit the present disclosure. Although the present disclosure has been illustrated in detail according to the foregoing embodiments, those having ordinary skills in the art should understand that modifications can still be made to the technical solutions recited in various embodiments described above, or equivalent substitutions can still be made to a part of technical features thereof, and these modifications or substitutions will not make the essence of the corresponding technical solutions depart from the spirit and scope of the technical solutions of some embodiments of the present disclosure.

What is claimed is:

1. A method for voice recognition based on dynamic voice model selection, comprising the following steps:
obtaining a first voice packet of a voice to be detected and extracting the basic frequency of the first voice packet, wherein the basic frequency is the vibration frequency of a vocal cord;
classifying the sources of the voice to be detected according to the basic frequency and selecting a pre-trained voice model voice model in a corresponding category; and
performing front-end processing on the voice to be detected to obtain the values of the characteristic parameters of the voice to be detected, and matching the processed voice to be detected with the voice model and scoring, thus obtaining a voice recognition result.

2. The method according to claim 1, wherein the obtaining the first voice packet of the voice to be detected further comprises:
performing voice activity detection on the voice to be detected to obtain the initial point of the voice to be detected; and
serving a voice signal with a certain time range after the initial point as the first voice packet.

3. The method according to claim 2, wherein the serving the voice signal with the certain time range after the initial point as the first voice packet comprises:
obtaining the voice data from the initial point to 0.3˜0.5 s after the time point as the first voice packet.

4. The method according to claim 1, wherein the extracting the basic frequency of the first voice packet comprises:
extracting the basic frequency of the first voice packet employing an algorithm based on time-domain and/or an algorithm based on spatial-domain, wherein the algorithm based on time-domain comprises an autocorrelation function algorithm and an average magnitude difference function algorithm, and the algorithm based on spatial-domain comprises a cepstrum analysis method and a discrete wavelet transform method.

5. The method according to claim 1, wherein the classifying the sources of the voice to be detected according to the basic frequency comprises:
determining the threshold range to which the basic frequency belongs according to a preset basic frequency threshold and classifying the sources of the voice to be detected according to the threshold range, wherein the threshold range has a unique corresponding relation with different sources of the voice.

6. The method according to claim 1, wherein the method, before the classifying the sources of the voice to be detected according to the basic frequency and selecting the pre-trained voice model in the corresponding category, comprises:
performing front-end processing on corpora from different sources to obtain the characteristic parameters of the corpora; and
training the corpora according to the characteristic parameters to obtain voice models corresponding to the different sources.

7. A device for voice recognition based on dynamic voice model selection, comprising the following modules:
a basic frequency extraction module configured to obtain a first voice packet of a voice to be detected and extract the basic frequency of the first voice packet, wherein the basic frequency is the vibration frequency of a vocal cord;
a classification module configured to classify the sources of the voice to be detected according to the basic frequency and select a pre-trained voice model voice model in a corresponding category; and
a voice recognition module configured to perform front-end processing on the voice to be detected to obtain the values of the characteristic parameters of the voice to be detected, and match the processed voice to be detected with the voice model and score, thus obtaining a voice recognition result.

8. The device according to claim 7, wherein the basic frequency extraction module is further configured to:
perform voice activity detection on the voice to be detected to obtain the initial point of the voice to be detected; and
serve a voice signal with a certain time range after the initial point as the first voice packet.

9. The device according to claim 8, wherein the basic frequency extraction module is further configured to:
perform voice activity detection on the voice to be detected to obtain the initial point of the voice to be detected; and obtain the voice data from the initial point to 0.3˜0.5 s after the time point as the first voice packet.

10. The device according to claim 7, wherein the basic frequency extraction module is further configured to:
extract the basic frequency of the first voice packet employing an algorithm based on time-domain and/or an algorithm based on spatial-domain, wherein the algorithm based on time-domain comprises an autocorrelation function algorithm and an average magnitude difference function algorithm, and the algorithm based on spatial-domain comprises a cepstrum analysis method and a discrete wavelet transform method.

11. The device according to claim 7, wherein the classification module is configured to:
determine the threshold range to which the basic frequency belongs according to a preset basic frequency threshold and classify the sources of the voice to be detected according to the threshold range, wherein the threshold range has a unique corresponding relation with different sources of the voice.

12. The device according to claim 7, wherein the device further comprises a voice model training module which is configured to:
perform front-end processing on corpora from different sources to obtain the characteristic parameters of the corpora; and
train the corpora according to the characteristic parameters to obtain voice models corresponding to the different sources.

13. An electronic device for voice recognition based on dynamic voice model selection, comprising:
at least one processor; and
a memory communicably connected with the at least one processor for storing instructions executable by the at least one processor, wherein execution of the instructions by the at least one processor causes the at least one processor to:
obtain a first voice packet of a voice to be detected and extract the basic frequency of the first voice packet, wherein the basic frequency is the vibration frequency of a vocal cord;
classify the sources of the voice to be detected according to the basic frequency and select a pre-trained voice model voice model in a corresponding category; and
perform front-end processing on the voice to be detected to obtain the values of the characteristic parameters of the voice to be detected, and match the processed voice to be detected with the voice model and score, thus obtaining a voice recognition result.

14. The device according to claim 13, wherein the obtain the first voice packet of the voice to be detected further comprises:
perform voice activity detection on the voice to be detected to obtain the initial point of the voice to be detected; and
serve a voice signal with a certain time range after the initial point as the first voice packet.

15. The device according to claim 14, wherein the serve the voice signal with the certain time range after the initial point as the first voice packet particularly comprises:
obtain the voice data from the initial point to 0.3˜0.5 s after the time point as the first voice packet.

16. The device according to claim 13, wherein the extract the basic frequency of the first voice packet further comprises:
extract the basic frequency of the first voice packet employing an algorithm based on time-domain and/or an algorithm based on spatial-domain, wherein the algorithm based on time-domain comprises an autocorrelation function algorithm and an average magnitude difference function algorithm, and the algorithm based on spatial-domain comprises a cepstrum analysis method and a discrete wavelet transform method.

17. The device according to claim 13, wherein the classify the sources of the voice to be detected according to the basic frequency further comprises:
determine the threshold range to which the basic frequency belongs according to a preset basic frequency threshold and classify the sources of the voice to be detected according to the threshold range, wherein the threshold range has a unique corresponding relation with different sources of the voice.

18. The device according to claim 13, wherein the at least one processor is further caused to:
perform front-end processing on corpora from different sources to obtain the characteristic parameters of the corpora; and
train the corpora according to the characteristic parameters, and obtain voice models corresponding to the different sources.

19. A non-transitory computer-readable storage medium storing executable instructions that, when executed by an electronic device, cause the electronic device to perform the method according to claim 1.
